(19) United States
(12) Patent Application Publication
(10) Pub. No.: US 2024/0199070 A1
(43) Pub. Date: Jun. 20, 2024

(54) METHOD FOR OPERATING A DATA PROCESSING SYSTEM

(71) Applicant: Robert Bosch GmbH, Stuttgart (DE)

(72) Inventor: Rainer Baumgaertner, Pfaffenhofen (DE)

(21) Appl. No.: 18/540,099

(22) Filed: Dec. 14, 2023

(30) Foreign Application Priority Data
Dec. 20, 2022 (DE) 10 2022 214 053.2

(51) Int. Cl. B60W 60/00

(52) U.S. Cl. CPC B60W 60/001

(57) ABSTRACT

A method for operating a data processing system for processing data. The data processing system is set up for the repeated execution of a plurality of data processing tasks. The method including: a) executing the individual data processing tasks at their relevant repetition rate in a time grid on one of the data processing units of the data processing system; b) outputting output data by the individual data processing tasks into respectively provided memory areas of the buffer memory, which are associated with the clock pulse of the grid, wherein output data generated by data processing tasks on second data processing units are transmitted after output via the data transmission interfaces into memory areas of the buffer memory on first data processing units; and c) reading in input data by the individual data processing tasks from respectively provided memory areas of the buffer memory.

### FIELD

The present invention relates to a method for operating a data processing system. The method and the data processing system can be used, for example, for processing data for partially automated and highly automated driving, for example in order to process environmental data from the surroundings of a motor vehicle for functions of driver assistance systems. Another area of application for the method described here for operating a data processing system is complex robotic systems.

### BACKGROUND INFORMATION

The complexity of data processing in this context is extraordinarily high. Very large volumes of data have to be processed at high speed. Large amounts of memory are required for the data to be processed. At the same time, the safety requirements are greatly increased, especially with regard to the so-called functional safety requirements. No errors must be allowed to occur during the data processing. Taking the functional safety requirements into account also increases system complexity.

Software that is operated on data processing systems for such applications often has a structure in which a complex cascade or a complex network of consecutive data processing modules processes input data to form output data, wherein individual data processing modules each process input data to form output data, wherein the output data can then be input data for other data processing modules. The individual data processing modules often function as filters that perform certain data processing functions. This data processing is often an image processing. Input data are often data from sensors (e.g., environmental data, in particular camera images). The individual data processing modules regularly form a complex network. The exchange of output data and input data between the various data processing modules regularly requires efficient mechanisms for the data transfer. At the same time, parallel data processing in different data processing modules is often necessary. This means, for example, that a first data processing module for receiving and processing camera images from an environment camera preferably works in parallel with a further data processing module which further processes the camera images processed by the first data processing module in order to develop decision data for a highly automated driving function on this basis.

In motor vehicles and robotic systems, central control units are usually provided which form the execution platform for software that is used, for example, for autonomous or partially or highly automated driving.

One or more so-called SOC (System on Chip) modules are normally installed in central control units. Each of these SOCs consists internally of a plurality of computing units. The computing units used include, for example, performance cores, safety cores, DSPs (digital signal processors), hardware accelerators, DNNs (deep neural networks), and hardware video image conditioning.

Memory modules on which data can be stored—in particular, output data of data processing modules, which can serve as input data for other data processing modules—also typically exist on such SOC modules.

Various concepts for accessing memory modules are normally realized in such SOC modules. Individual computing units usually each have associated memory modules on which they can preferably store data. Some embodiments also have computing units with memory modules which other computing units can directly access. Other computing units can then preferably process output data, stored there, directly as input data.

Some embodiments have computing units which are separated from further computing units in terms of storage technology. In order to be able to further process data with such computing units, it is necessary to transmit these data to the memory modules of the corresponding computing units via corresponding interfaces. The possibility of data transmission via such interfaces is beset with further special challenges. Physical signal transit times and the resulting latencies have a great importance.

Software that is operated on such hardware and that is intended to effectively utilize the performance of such hardware must be strongly adapted to the hardware. In particular, the desire to utilize many computing units on a single chip as effectively as possible poses extreme challenges in software development and in the analysis of problems in the software/during debugging.

Copying data when transferring between different data processing modules is often to be avoided, for performance reasons. Data processing modules are often intended to read input data from the memory of a SOC module where upstream data processing modules or their data processing steps have stored this data from output data. In this way, copying processes that have to be managed by an operating system can be avoided and the overall data processing performance can be greatly increased.

Approaches in the software structure that make the complexity manageable are extremely important in order to be able to develop and maintain such software efficiently. The keyword “deterministic” operation is extremely important in this context. In particular, in the case of data processing modules that build on one another and operate in parallel with one another, it is important to be able to understand which data processing module is processing which input data at which time. It often also has to be ensured that different data processing modules process the same input data.

Given unordered access to the available input data, in some circumstances this may not be achievable, or may be achievable only with very high effort. Through deterministic communication, here the data on which the particular data processing is based are unambiguously determined. Such determinism can for example be achieved at least in part by means of a temporally predetermined communication, which is characterized in particular by the fact that the times at which input data and output data are exchanged between individual modules are unambiguously determined.

A frequently used principle for the communication of data processing modules is the “single publisher multiple subscriber” scheme (one party can write and publish data, a plurality of parties can have read access to this data). This is one approach to achieving copy-free data transfer. Such copy-free methods for data exchange again increase the complexity because they may require dynamic memory management, which monitors where output data are stored in each case, ensures that there is no unwanted overwriting of output data which are processed by other modules as input data, and so on. In addition, the methods used nowadays often lead to a temporal decoupling of the communication. This requires additional effort in software development and maintenance in order to be able to track which data are processed when and how.

### SUMMARY

An object of the present invention is to provide an advantageous method for operating a data processing system.

The present invention relates to a method for operating a data processing system for processing data, wherein the system is set up for the repeated execution of a plurality of different data processing tasks. According to an example embodiment of the present invention:
a time grid with a clock pulse is provided for the execution of the individual data processing tasks,
a predetermined repetition rate is specified for each data processing task, wherein the repetition rates each define a repetition clock pulse which corresponds in each case to an integer number of clock pulses of the grid;
the repetition clock pulse of the data processing task with the highest repetition rate corresponds to the clock pulses of the time grid;
data processing tasks build on one another, so that at least one data processing task processes output data of a further data processing task as input data;
a number of buffer memories are provided, which are assigned to the clock pulses of the time grid and are available in turn, so that output data generated during the relevant clock pulse are written to the relevant buffer memory and output data generated during previous clock pulses for a number of clock pulses are still available in other buffer memories,
the data processing system is operated on a data processing device comprising at least one first data processing unit and comprising at least one second data processing unit, which in each case have processors and memory modules, wherein data transmission interfaces exist for data transmission between the data processing units, wherein the data processing tasks are associated with at least one first data processing unit or at least one second data processing unit, and memory areas of the buffer memories are made available to the memory modules of the corresponding data processing units,
   wherein, according to an example embodiment of the present invention, the following steps are carried out for the operation of the data processing system:
a) executing the individual data processing tasks at their respective repetition rate in the time grid on one of the data processing units of the data processing system,
b) outputting output data by the individual data processing b) tasks into respectively provided memory areas of the buffer memory, which is associated with the clock pulse of the grid, wherein output data generated by data processing tasks on second data processing units are transmitted after output via the data transmission interfaces into memory areas of the buffer memory on first data processing units, and
c) reading in input data by the individual data processing tasks from respectively provided memory areas of the buffer memory, which are associated with the preceding clock pulses of the grid, wherein input data, which are required by data processing tasks on second data processing units, are transmitted into memory areas of the buffer memory on second data processing units before being read in via the data transmission interfaces.

The method described here represents a supplement to an operating method in which the transmission of output data described in step b) and the transmission of input data described in step c) are not required because all data processing tasks are performed by data processing units which can mutually and coherently mutually access (without deviations of the respectively visible data) their memory modules. By means of the method described here, it is possible to integrate further data processing units, for which no coherent memory access is possible, into such a method that is based on coherent memory access options. In this case, the method allows, both on memory-coupled (both coherent and non-coherent) units and units connected to low-latency interfaces, deterministic communication on the basis of the master clock pulse, and a “freedom of interference” synchronization of the slave by the master.

Even during a data processing operation with a plurality of data processing units, which in principle enable coherent memory access, it can be important to operate certain additional measures which contribute to the functioning of the coherent memory access as intended under all conditions during the data processing operation.

For example, it can be useful to perform, upstream of step a), a synchronization function as step aₚᵣₑ), which will be discussed in detail below:
aₚᵣₑ) executing a synchronization function in each clock pulse before the start of the relevant data processing task, in order to achieve synchronization of the buffer memories for a plurality of first data processing units;

The method according to an example embodiment of the present invention described here is preferably used in addition in a data processing system, in which a plurality of first data processing units work together in principle with memory coherency using the synchronization function, and in which second data processing work takes over data processing tasks under the control of first data processing units. Reference is therefore also made below to “method for coherent memories” and “method for incoherent memories.” The method described primarily here is the method for incoherent memories. When reference is made to the “method described,” the method for incoherent memories is primarily meant, unless the context provides otherwise. When reference is made to the method for coherent memories, reference is largely made explicitly thereto, or it results from the context. The synchronization function described in detail below is part of the method for coherent memories.

In preferred embodiments of the present invention, the method for coherent memories and the method described here for incoherent memories are both used to enable first data processing units to cooperate with one another, and simultaneously to enable first data processing units to be supported by second data processing units.

In the following, the method for coherent memories with the synchronization function will first be explained in detail. The method described here for incoherent memories is then additionally explained.

According to an example embodiment of the present invention, it is preferable, between first data processing units, for output data of data processing tasks to be further processed as input data for other data processing tasks, in principle, without a copying operation.

Output data from data processing tasks are preferably physically stored in the buffer memory. At the exact location where the output data are stored, further data processing tasks read in these output data as input data. This concept can also be referred to as “copy free” communication. The communication described herein of input data and output data using the method described herein therefore preferably takes place in “copy free” fashion. This concept is applied in particular to the input data and output data described herein. Other messages can be exchanged between the data processing modules using other methods (in addition to the method described herein).

According to an example embodiment of the present invention, it is particularly advantageous if the synchronization function in step aₚᵣₑ) enables external memory accesses by data processing units to memory modules of other first data processing units, in which it is ensured that all output data of previously executed data processing tasks are available.

Moreover, according to an example embodiment of the present invention, it is advantageous if at least one cache memory in at least one first data processing unit is emptied by the synchronization function in step aₚᵣₑ) and data contained therein are stored on a memory module of the first data processing unit in such a way that external memory accesses by other first data processing units to this data are enabled.

The data processing system is in particular a SOC system (SOC=System on Chip), which is set up with software to perform complex data processing tasks that enable, for example, functions of autonomous, highly automated or partially automated driving.

The data processing task is preferably carried out by a data processing module which is set up for carrying out the corresponding data processing task. The data processing module is preferably software that is set up to process input data (e.g., of a camera image or another data set) and generates output data based on this. The input data preferably have a specific format, which must be adhered to so that the data processing module can process said data. The data processing module is, for example, a filter or a program function. The data processing task refers to the one-time execution of the data processing module with specific input data. Each individual execution of the data processing module in the grid is referred to as a data processing task. A plurality of executions of the data processing module in temporal succession is also referred to as “data processing tasks.” Different types of data processing tasks that build on each other are also referred to here as a “plurality” of data processing tasks. Each data processing task can also be referred to as a “task.”

The method according to the present invention described here reduces the complexity during communication and thus enables efficient deterministic communication, even from a copy-free point of view. This is achieved by using a deterministic communication concept. The grid of tasks defines a cyclical task system.

Buffer memories are preferably reserved for a number of clock pulses. For example, there are buffer memories for a total of 8 clock pulses. Buffer memories are defined here at the level of the clock pulses. Different data processing tasks can have their own memory areas within a clock pulse for storing their output data. Preferably, a memory area for storing output data of a specific data processing task is located within a buffer memory for a specific clock pulse whenever the repetition clock pulse of the data processing task specifies this. An example: if the repetition clock pulse of the data processing task corresponds to four times the clock pulse of the grid, then, preferably in every fourth buffer memory for a clock pulse, there is a memory area for the relevant data processing task for storing its output data. The data processing tasks then place their output data into the buffer memories in turn, so that (in this case) each buffer memory is written with output data every eight clock pulses. For example, one of the buffer memories is always written to by one of the data processing tasks, so that the output data from seven previous executions of the data processing task is then always still available. This takes place in steps b) and c). During each clock pulse, there is a unique assignment to a buffer memory that is “active” for this clock pulse. And, if applicable, there is a unique assignment to an associated data processing task (or tasks) whose repetition clock pulses end at this clock pulse. Output data from the data processing task can be written to this buffer memory. In this case, a write access to the other seven buffer memories is then not possible. The data can be read from each of these buffer memories as input data by other data processing tasks in accordance with step d). In the present example case of eight buffer memories, the output data from seven previous executions of data processing tasks are available. After 8 clock pulses have passed, the data processing tasks always start again to overwrite the content of previous executions of the data processing tasks. This is possible because all the data processing tasks run in a common time grid. In the example, after the 8th clock pulse, it is ensured that the data from the previous 7 clock pulses have been received by the other data processing tasks. The buffer memories of the individual clock pulses are filled with output data in cyclical/rotating/rolling fashion by the data processing tasks.

In the method according to the present invention described here, buffer memories are to be understood as an overarching conceptual/virtual structure formed by memory areas in memory modules of the individual first data processing units of the data processing device. From the perspective of the individual data processing modules which contain the program code to be executed of the individual data processing tasks, it is irrelevant which memory areas belong to the buffer memories. When implementing the program code of the data processing modules, it is preferably of no or at least of secondary relevance where (in which memory area or on which memory module) the data processing task stores output data. The buffer memories are therefore preferably a concept from the perspective of the respective data processing tasks. Preferably, data processing tasks executed by a particular first data processing unit also store output data, which they themselves produce, in a memory area which is provided on a memory module of that first data processing unit and which can be accessed by relevant sending and receiving data processing tasks.

The buffer memory concept offers decisive advantages in terms of reducing the complexity of and the expenditure on management and computing time required for communication. In addition, a very advantageous implementation of deterministic communication also results from a copy-free point of view. The approach that buffer memories can extend in a certain way over memory areas on different memory modules of different first data processing units of a data processing device makes it possible to apply the concept of buffer memories even if the data processing is carried out, using the data processing system described herein, in distributed fashion over different first data processing units of a data processing device, wherein the memory modules of the first data processing units are not coherent or consistent in their basic structure.

The statement that the memory modules of the first data processing unit are not coherent or consistent in their basic structure means that, in certain situations, memory accesses can read out different data from the memory, depending on whether the memory access is an internal memory access from the first data processing unit itself or an external memory access from another first data processing unit of the data processing device.

The method according to the present invention described here is suitable for coherent memories for operation on data processing devices in which the first data processing units participating in the method are able to carry out read access and, if appropriate, also write access to memory modules of other first data processing units participating in the method. However, such accesses (at least write accesses) are regularly slower than accesses to the first data processing units' own memory modules. This is due in particular to the fact that special mechanisms/devices preferably exist within the first data processing units to accelerate access to their own memory modules, in particular memory caches. Write caches are particularly preferred. If data (e.g., the output data described here) are written to the memory area, it can happen that these data do not actually/physically land directly on the memory module, but at first only in a memory cache (e.g., in the write cache), from which these data are then stored on the memory module itself as soon as the data lines (pipelines) provided for this purpose are free. This is also a reason why external memory accesses or internal memory accesses can show different data. However, this is remedied by the described synchronization function carried out in step a). The synchronization function carried out in step a) ensures that internal memory accesses and external memory accesses always return the same data (in relation to the clock pulse) and therefore the output data stored in the memory areas in the previous clock pulses are always output correctly, regardless of the type of access. The synchronization function establishes or ensures a so-called memory coherence.

This is achieved, for example, in that cache memories within the data processing units are preferably fully emptied by the synchronization function. In particular, this means that the relevant content of the particular cache memory is transferred fully to the designated memory area on the memory modules (via the data lines/pipelines provided for this purpose).

The described method of the present invention for coherent memories is particularly preferred if the synchronization function is in each case executed in advance of the data processing task with the highest repetition rate.

According to an example embodiment of the present invention, it is also preferred if the synchronization function is executed for each of the data processing units.

For example, memory caches of the data processing units taking part in the described method are emptied by the synchronization function.

In addition, the described method of the present invention for coherent memories is preferred if the synchronization function has an execution priority corresponding to the execution priority of the data processing task with the highest priority.

The synchronization function is preferably executed as a so-called pre-task to the data processing task with the highest repetition rate, i.e., temporally before the data processing task with the highest repetition rate.

In variant embodiments of the present invention, the synchronization function can also be integrated into the data processing task with the highest repetition rate or with the highest priority or be integrally connected to this data processing task—for example, as the first program function implemented within the data processing module for the data processing task.

This ensures the memory consistency of the individual first data processing units once per clock pulse. It has been found that establishing memory consistency once per clock pulse requires considerably less effort than establishing memory consistency individually at the message level. Overall, the synchronization processes required to establish memory consistency are greatly reduced by using the described fixed grid of clock pulses. This applies even though the synchronization is carried out at the highest intended repetition rate (at the level of the clock pulses of the grid). This applies in particular because, in order to execute the synchronization function, it is not necessary to take into account which output data are actually synchronized by which data processing module. The synchronization function can work independently of the exchange actually taking place of data between the data processing tasks.

If necessary, the synchronization function can, however, use existing knowledge about the relationships and the execution location of the individual data processing tasks to further reduce the synchronization effort, wherein the location of the execution here in particular indicates on which first data processing unit the corresponding data processing task is or was executed, and wherein the relationships here are in particular information about which further data processing tasks to be executed further process the generated output data.

In such variant embodiments of the present invention in which relationships and the execution location are taken into account, cache memories (in particular, write buffers, caches, and pipelines of the individual first data processing units) are preferably emptied, i.e., flushed or invalidated, as required. This includes in particular a so-called “invalidate-refresh,” which forces data to be read again from a memory. This takes place at the sender side, i.e., in the first data processing units in which the data processing tasks processing output data were performed. Finally, in the synchronization function suitable measures are to be provided that fill the respective memory modules with the output data in such a way that internal memory accesses and external memory accesses yield the same data. Preferably, special memory coherence mechanisms of the individual first data processing units are also used as required for this. These include, for example, fences and memory barriers and specific peripheral accesses to achieve memory coherence.

As a result, consistent data are available to the individual first data processing units that use the method. The potential lack of memory coherence of the hardware computing units is compensated for thanks to the deterministic communication and the synchronized cyclic operation of the method with regard to the communication described in the method.

The method according to the present invention is preferably designed to be copy-free. “Copy free” means, for example, that the output data of a data processing task are not copied, so that they can be used as input data by other data processing tasks. The data processing tasks retrieve their input data from the location in the memory where they were previously stored. The respective areas where data are stored and read in are permanently stored. It is also particularly advantageous that a static buffer management is static. Memory areas which form the individual buffer memories are permanently stored for the entire data processing system and are preferably not changed during the runtime of the data processing system. This means that their addresses, via which data processing modules can access the buffer memories or their memory areas, are not changed. The content of the buffer memories or the content of their memory areas naturally changes regularly during the runtime of the method due to the work of the data processing tasks.

It has been described that a repetition clock pulse or repetition rate is preferably defined for the individual data processing tasks. The data processing task with the highest repetition rate has the shortest repetition clock pulse, which preferably corresponds to the time grid of clock pulses.

Preferably, the repetition clock pulses of the individual data processing tasks are in each case integer multiples of each other. The individual data processing tasks can also be referred to as cyclical tasks, which are in an integer cycle relationship to each other.

If necessary, however, the data processing system can be integrated into a higher-level, larger data processing system in which only some of the tasks operate according to the method described here. In such a data processing system, which is higher level relative to the data processing system described herein, there may therefore be further tasks with which communication preferably does not take place in the manner described here, or takes place with other methods.

A system of cycles of repetition clock pulses and repetition rates of the data processing tasks working together according to the method according to the present invention described herein can for example be:
clock pulse length of the grid: 1 ms [millisecond];
repetition rate of the data processing task with the highest repetition rate: 1000 [1/s repetitions per second]=repetition rate 1 ms [millisecond];
repetition rate of a further data processing task 200 [1/s repetitions per second]=repetition clock pulse 5 ms [milliseconds];
repetition rate of a further data processing task 100 [1/s repetitions per second]=repetition clock pulse 10 ms [milliseconds]; and
repetition rate of a further data processing task 10 [1/s repetitions per second]=repetition clock pulse 100 ms [milliseconds].

The transfer of output data from one data processing task as input data to another data processing task is also referred to here as “communication” of the data processing tasks. The communication takes place in deterministic fashion. Communication takes place in “single publisher multiple subscriber” fashion (one is permitted to write and publish data; a plurality are permitted read access to these data).

According to an example embodiment of the present invention, it is also advantageous if data processing tasks intended for execution are activated at the start times of each clock pulse, wherein the start of data processing tasks with a higher repetition rate takes place temporally before the start of data processing tasks with a lower repetition rate.

According to an example embodiment of the present invention, it is also advantageous if the execution of data processing tasks with a higher repetition rate is prioritized over the execution of data processing tasks with a lower repetition rate.

Preferably, according to an example embodiment of the present invention, an operating system with which the software of the data processing system described herein is operated on hardware and the configuration of this operating system ensures that the higher-frequency data processing tasks have a higher priority and are therefore always preferentially executed. Preferably, activation of the data processing tasks/task activation is done in such a way that the high-frequency data processing tasks are activated earlier than or at least simultaneously with the low-frequency data processing tasks.

In the vast majority of cases, the data processing tasks with the higher repetition rate are started further up, i.e., earlier, in a cascade of data processing tasks, building on one another, of the data processing system described herein. Here is a highly simplified example: the data processing task with the highest repetition rate structures, e.g., camera images as input data and outputs them as output data, which are then used by subsequent data processing tasks to perform traffic sign recognition, for example.

The order of processing, in which the data processing tasks with the highest repetition rate come first, can ensure, for example, that the output data of the data processing tasks with the highest repetition rate are always available when the data processing tasks with the lower repetition rate start. Due to the fact that the data processing tasks with the low repetition rate build on the data processing tasks with the higher repetition rate, the described prioritization causes the data processing system as a whole to behave as if all data processing tasks were started at exactly the same time, which is regularly not possible due to the structure of the hardware and the operating system.

According to an example embodiment of the present invention, it is also advantageous if the buffer memories are structured in such a way that memory areas are provided within the buffer memories for specific output data from data processing tasks.

Preferably, according to an example embodiment of the present invention, the memory areas of the buffer memories for specific output data are each provided in the first data processing units on which the data processing tasks that generate the respective output data are also executed.

According to an example embodiment of the present invention, it is also advantageous if, for data processing tasks that obtain input data from buffer memories, it is specified from which memory areas of the buffer memory the input data are to be read.

Memory areas are therefore fixedly defined for individual data processing tasks in the buffer memories. During the runtime of the data processing system, the buffer memories and the memory areas in the buffer memories are preferably not changed.

According to an example embodiment of the present invention, buffer memories preferably exist at the clock pulse level. That is, a buffer memory is provided for each clock pulse. Particularly preferably, these buffer memories are each subdivided into fixedly defined memory areas, each of which forms memory space for storing output data of specific data processing modules or data processing tasks. Thus, each buffer memory preferably contains a plurality of messages from different data processing tasks.

If necessary, the buffer memories for different clock pulses can also be partitioned differently with different memory areas. This can be helpful because, for example, in certain clock pulses, it is known that a plurality of data processing tasks are restarted here, so that output data from different data processing tasks are produced. It is also possible that the number of past clock pulses from which output data are held available (not overwritten) is different for different data processing tasks. It is also advantageous to divide the buffer memories into further sub-buffers so that a separation of data can take place. This can be used particularly advantageously to meet safety requirements; i.e., the achievement of “freedom of interference.” In particular, it is possible to protect the individual buffer memories from each other with regard to access, to block them for individual data processing tasks, etc. Such functions can be provided by an operating system.

According to an example embodiment of the present invention, it is particularly advantageous if messages between the data processing tasks are only exchanged via the buffer memories, so that communication between the data processing tasks only takes place via the buffer memories.

The term “messages” here refers to input data and output data that are exchanged between the data processing modules in the data processing system that work together according to the method. The term “messages” refers in particular to communication which is not controlled by a higher-level operating system or a higher-level controller, but which takes place in uncontrolled fashion on the buffer memories between the individual data processing tasks according to the method described here. A higher-level operating system or a higher-level controller only provides the buffer memory. The exchange of input data and output data is self-organizing according to the method described here. The term “messages” does not refer to other communication that may be required to monitor and control the data processing tasks and that may take place via other channels or the operating system.

According to an example embodiment of the present invention, it is also advantageous if the selection and addressing of the buffer memories is calculated using associated task counters of the data processing tasks involved.

Preferably, according to an example embodiment of the present invention, access to the buffer memory assigned to the relevant clock pulse takes place via a mechanism that strictly counts the clock pulses. This mechanism can also be referred to as a clock pulse counter or task counter. The individual buffers can preferably also be addressed quasi-statically using simple arithmetic on the basis of the relationship between the clock pulses of the relevant data-sending data processing task and the clock pulses of the relevant data-receiving data processing task or of the clock pulse counter/task counter. Dynamic management of the buffers is therefore not necessary. This significantly reduces the effort involved in developing and analyzing the software of the data processing system.

Preferably, according to an example embodiment of the present invention, the addressing of the individual buffer memories is structured in such a way that a memory address of the buffer memory valid in each case can be generated directly from the task counter or the clock pulse counter or the clock pulses of the data-sending and data-receiving data processing tasks involved. Particularly preferably, the current value of the task counter flows into the respective memory accesses during the writing of output data or reading of input data by data processing modules, in such a way that no individual consideration of the system of buffer memories is made at all for the programming of the individual data processing module. Due to the structure of the buffer memories in conjunction with the task counter and suitable addressing, the individual data processing tasks preferably automatically store output data in the correct buffer memories and also automatically receive input data from the correct buffer memories.

According to an example embodiment of the present invention, it is also advantageous if the number of buffer memories is selected so that all input data are available that are required for the execution of each data processing task and that have been generated during previous clock pulses as output data of other data processing tasks.

According to an example embodiment of the present invention, a relatively large amount of memory in the form of the described buffer memory may have to be reserved in order to use the described method, especially if access to output data further in the past is also required for the data processing according to the described method.

In addition, according to an example embodiment of the present invention, it is advantageous if the data processing system has a communication memory, wherein information is stored in the communication memory as to which output data are stored in which memory areas of the buffer memories.

Such a communication memory preferably has no mechanisms that allow deviations between the external memory access and the internal memory access, and thus preferably represents a secure communication path between the individual data processing units of the data processing device. However, such a communication memory usually has other disadvantages. For example, it allows lower data transfer rates, is slower, etc.

Such a communication memory can offer alternative possibilities for implementing the described synchronization function. For example, the synchronization function can store information in the communication memory that indicates to the data processing tasks processing the output data where or how the output data can be accessed.

According to an example embodiment of the present invention, it is also advantageous if, for step a), a controller of the data processing system, which controller is higher level relative to the data processing outputs, determines on which data processing unit a data processing task is executed.

If necessary, this can be done in advance (as already described above) before the data processing is carried out with the data processing system or, if necessary, also during runtime, for example to distribute data processing tasks to different data processing units in a load-dependent manner.

In addition, according to an example embodiment of the present invention, it is advantageous if, for steps b) and c), a controller that is higher level relative to the data processing tasks determines on which memory area of a buffer memory particular data processing tasks will store their output data so as to be capable of being read in as input data by other data processing tasks.

According to an example embodiment of the present invention, preferably, data are always stored in the memory modules of the data processing tasks in which the data processing tasks are also executed, because in particular mechanisms for accelerating the processing (e.g., cache memory) can then be used effectively. However, deviations may also occur here, depending on requirements, which do not run counter to the basic idea of the method described herein.

In particular, the operating method for coherent memories was explained above. The method described here for incoherent memories is described in detail below, wherein reference is made to the above explanations relating to the method for coherent memories.

The method according to present invention described here is preferably set up such that it is not essential to the software development of data processing modules for executing data processing tasks and the entire data processing system that data processing tasks be carried out partially on second data processing units which do not have a coherent memory with first data processing units. The described method achieves that such second data processing units are inserted into a network of first data processing units and cooperate quasi-coherently with first data processing units from the outside or from above (from the perspective of a higher-level control or from the point of view of a higher-level operating system).

The method according to the present invention described explains the data processing from a higher-level perspective with steps a), b), and c). The steps a), b), and c) run permanently in parallel with one another for all data processing tasks—optionally supplemented by the step aₚᵣₑ) described further above for synchronizing the first data processing units. Data transmissions described in step b) and ?) are performed for all input data which are processed by data processing tasks on second data processing units and for all output data which are generated by data processing tasks on second data processing units.

According to an example embodiment of the present invention, it is particularly advantageous if the at least one first data processing unit is a data processing unit optimized for error reduction, and wherein the at least one second data processing unit is a data processing unit optimized for power.

First data processing units optimized for error reduction have, for example, additional safety functions implemented in hardware, such as, for example, the entrainment of test sums implemented in hardware, etc. Second data processing units optimized for power can process larger amounts of data in a shorter time. First data processing units are preferably so-called “μC” or “μS” units (“C” in this case stands for “control” and “S” for “safety”). Second data processing units are preferably so-called “μP” units. (“P” here stands for “performance”.)

In the method according to the present invention described, first data processing units take over the control. Second data processing units operate under the control of first data processing units and take over certain (in particular, computationally intensive) tasks. This type of cooperation enables efficient data processing.

According to an example embodiment of the present invention, it is also advantageous if the execution of data processing tasks on second data transmission units according to step a) is started by a trigger signal, which is sent by first data processing units when a transmission of output data to the respective second data processing unit according to step b) is concluded.

In the use of the trigger signal to start the processing of data processing tasks in second data processing units, it is not necessary for second data processing units to control the grids and the clock pulses of the grid or to orient themselves thereby. The fact that second data processing units work in the grid is controlled by the first data processing units using trigger signals. If not all input data which are required for the processing of the respective data processing tasks are available, first data processing units or the data processing tasks executed therefrom assume the function of canceling the operation of the data processing system or of outputting error messages.

In addition, according to an example embodiment of the present invention, it is advantageous if data processing tasks to be carried out by second data processing units are implemented in such a way that a sub-period of the repetition clock pulse of the data processing task is sufficient to complete the data processing, wherein the sub-period is selected such that, within the repetition clock pulse, there is still time remaining for transmitting output data according to step b) and for transmitting input data according to step c).

According to an example embodiment of the present invention, the sub-period is preferably between 20 percent and 80 percent of the length of a clock pulse—for example, 50 percent. The clock pulse length and the performance of the second data processing units, and the implementation of the data processing tasks and the transmission speed via the data transmission interfaces according to steps b) and c) must be coordinated with one another in such a way that compliance with a predefined sub-period is possible and is always maintained during operation. In the method described, it is preferably checked before the start of the data processing tasks or when the described trigger signal is transmitted whether all input data for carrying out the data processing tasks are present (in the memory provided in each case), so that the data processing tasks can run correctly. If this is not the case, an error message is output, and the described method is aborted.

The transmission interface may, for example, be a PCI express interface. The transmission interface can also be realized with provided divided memory areas via which the data are transmitted. In principle, a wide variety of embodiment variants of transmission interfaces are possible or applicable for the method described and the described data processing device or the described data processing system.

According to an example embodiment of the present invention, it is also advantageous if, in addition to the data processing tasks, further data processing operations, which are executed within the remaining time, are performed on second data processing devices so that the capacity of the second data processing device is fully available for the execution of the data processing task during the sub-period.

Further data processing tasks can be any downstream data processing operations which, to a certain extent, the second data processing units perform as gap fillers during the transmission of data. By using the remaining time for further data processing, the processing capacity remaining on the second data processing units by complying with the sub-period does not remain unused. By suitably assigning priorities, it can be ensured that such further data processing operations do not impair the operation of the method described here (compliance with the sub-period). In the context of the described method, data processing tasks executed on second data processing units are preferably provided with a higher priority than further data processing operations which are to be executed on second data processing units in the remaining time. If the capacity of a computing capacity of the second data processing unit is then sufficient, the processing of the data processing tasks then takes place in the sub-period, and as many further data processing operations as possible can be carried out in the remaining time. Mechanisms are preferably provided in second data processing tasks which prevent second data processing tasks from being blocked or jammed by further data processing operations. In other words, second data processing units are preferably set up such that a processing of data processing tasks as part of the described method is not blocked within the time period by further data processing operations.

According to an example embodiment of the present invention, it is also advantageous if the time grid is specified by first data processing units, and a clock pulse shift can occur between clock pulses of first data processing units and clock pulses of second data processing units, which clock pulse shift is post-synchronized regularly by trigger signals from the first data processing units to second data processing units.

As already explained above, the execution of data processing tasks on the second data processing units depends on the first data processing units and is started by the trigger signal. A time lag of the grid of (theoretically) a maximum of one cycle is possible in principle as long as the output data of the data processing executed on the second data processing units arrive at the first data processing unit again in a timely manner.

Second data processing units preferably send output data generated there independently via the transmission interface to the first data processing units. If the output data arrive there in a timely manner (within the corresponding clock pulse), the implementation of the described method can be continued. Further data processing tasks (associated with the following clock pulse) can be started at the beginning of the next clock pulse, and trigger signals for activating data processing tasks on second data processing units can be sent off. Optionally, the transmission of data to the second data processing units is also possible after the start of the next clock pulse, which data are required there as input data for data processing tasks. Since the second data processing units operate in a manner fully dependent on first data processing units, it is unproblematic for the start of the processing of the data processing tasks to shift here. It is important only that the end of the processing take place in a timely manner, so that the described return transmission of data via the data transmission interface according to step b) takes place.

According to an example embodiment of the present invention, it is also advantageous if a transmission of input data for data processing tasks, which are executed on second data processing units, to second data processing units by first data processing units is initiated after said input data have been stored as output data in the buffer memory of a first data processing unit.

According to an example embodiment of the present invention, it is furthermore advantageous if the transmission of input data from a first data processing unit to a second data processing unit takes place in parallel with the execution of further data processing tasks on the first data processing unit.

The transmission of data to second data processing units preferably does not block or impair the execution of data processing tasks on first data processing units.

According to an example embodiment of the present invention, it is also advantageous if a first data processing unit monitors that second data processing units terminate associated data processing units such that the output data are available to the data processing of preceding clock pulses in each clock pulse. This monitoring can take place by checking the output data of the data processing tasks executed on second data processing units by the first data processing units—in particular, by checking whether these output data are fully present after transmission in the memory areas on the memory modules of the first data processing units.

According to an example embodiment of the present invention, it is particularly advantageous if, for step a), a controller of the data processing system, which controller is higher level relative to the data processing tasks, determines on which data processing unit a data processing task is executed.

As in the method for coherent memories, this is preferably done either before the runtime or during the runtime. A partial determination in advance outside the runtime and then a (for example, load-dependent) adaptation of the assignment of data processing tasks to data processing units during the runtime is also possible.

In addition, according to an example embodiment of the present invention, it is advantageous if, for steps b) and c), a controller that is higher level relative to the data processing tasks determines on which memory area of a buffer memory particular data processing tasks will store their output data, so as to be capable of being read in as input data by other data processing tasks.

According to an example embodiment of the present invention, it is also advantageous if a higher-level control of the data processing system is operated on a data processing unit optimized for error reduction.

A higher-level controller is thus preferably operated on first data processing units, and not on second data processing units.

Also described herein is a data processing device according to the present invention having at least one first data processing unit optimized for error reduction and comprising at least one second data processing unit optimized for performance, which each have one or more processors and one or more memory modules, wherein the data processing device is configured such that it can be operated as a data processing system according to the described method.

Such a data processing device preferably has at least two first data processing units, which each have one or more processors and one or more memory modules, and at least one (preferably at least two) second data processing units.

According to an example embodiment of the present invention, the data processing device preferably has an operating system or a higher-level controller which takes over the execution of the individual data processing tasks and the provision of the buffer memories on the memory module (s).

The program code of the data processing modules is preferably located on the memory module (s) and is executed on the processors of the data processing device as a data processing task. Through the data processing tasks, the communication of input data and output data takes place on the buffer memory in accordance with the described method of the present invention.

Further described herein is a computer program product according to the present invention comprising commands which, when the computer program product is executed by a computer, cause the computer to carry out the described method of the present invention.

Further described herein is a computer-readable storage medium according to the present invention comprising commands which, when executed by a computer, cause the computer to carry out the described method according to the present invention.

The method of the present invention and the technical environment of the method are explained in more detail below with reference to the figures. The figures show preferred exemplary embodiments, to which the method of the present invention is not limited. It should be noted, in particular, that the figures and in particular the size proportions shown in the figures are only schematic.

### BRIEF DESCRIPTION OF THE DRAWINGS

FIG. 1 generally shows a deterministic communication scheme, according to an example embodiment of the present invention.

FIG. 2 shows a first variant embodiment of deterministic communication via buffer memories, according to the present invention.

FIG. 3 shows a second variant embodiment of deterministic communication via buffer memories, according the present invention.

FIG. 4 shows a third variant embodiment of deterministic communication via buffer memories, according to the present invention.

FIG. 5 shows a variant embodiment of deterministic communication via buffer memories according to FIGS. 2 to 4, executed on a data processing device having a plurality of data processing units, according to the present invention.

FIG. 6 shows a data processing device for the described method, according to the present invention.

FIG. 7 is a schematic representation of the cooperation of first data processing units and second data processing units for the described method, according to the present invention.

FIG. 8 shows a flowchart of the described method, according to the present invention.

### DETAILED DESCRIPTION OF EXAMPLE EMBODIMENTS

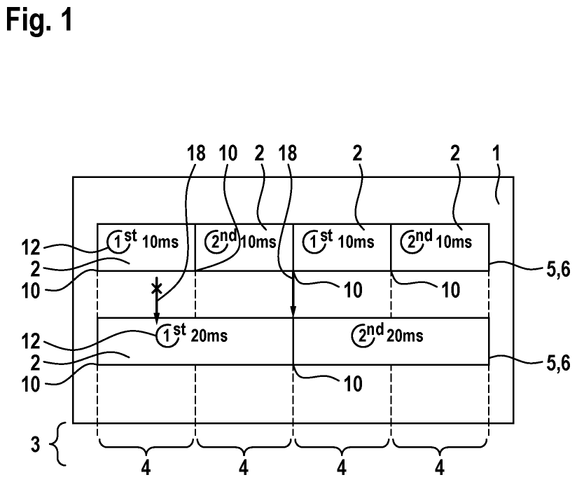

The representation of data processing systems 1 in FIGS. 1 to 4 is structured in the form of a timeline on which a grid 3 of clock pulses 4 is shown. Different data processing tasks 2 are shown in rows. A plurality of executions of data processing tasks 2 with different input data are shown one after the other in each row. The data processing tasks 2 are executed repeatedly in the grid 3 of clock pulses 4 with predefined repetition rates 5 and repetition clock pulses 6. This representation of a data processing system 1 serves the purpose of visualizing the communication between data processing tasks 2. Each data processing task 2 is represented as a block which is integrated into the grid 3 of clock pulses 4. Each data processing task 2 has a start time 10. Preferably, for each type of data processing task 2, there is a task counter which counts through the individual repetitions of the relevant data processing task 2.

FIG. 1 generally illustrates a deterministic task system for starting data processing tasks 2 in a data processing system 1 which is frequently used. The data processing tasks 2 are executed repeatedly in the grid 3 of clock pulses 4 with predefined repetition rates 5 and repetition clock pulses 6. Here, the communication of output data and input data between individual data processing tasks 2 takes place deterministically, but in the form of messages 18 which are exchanged individually between individual data processing tasks 2, the exchange of which may have to be controlled by an operating system. The effort required to develop the program code for data exchange is considerable here.

Deterministic communication is characterized by the fact that messages 18 are always exchanged at fixed times—for example (as shown here), at the end of a clock pulse. The exchange of messages 18 at arbitrary times is prohibited. A corresponding prohibited message 18 (i.e., not permissible in the context of deterministic communication) is shown crossed out in FIG. 1.

Preferably, principles such as “single publisher multiple subscriber” (one is permitted to write and publish data, and a plurality are permitted read access to these data) are also used in the schemata according to FIG. 1, to enable copy-free solutions for exchanging the messages between the data processing tasks 2. In these so-called copy-free methods, complexity increases further, since, for example, dynamic buffer management becomes necessary.

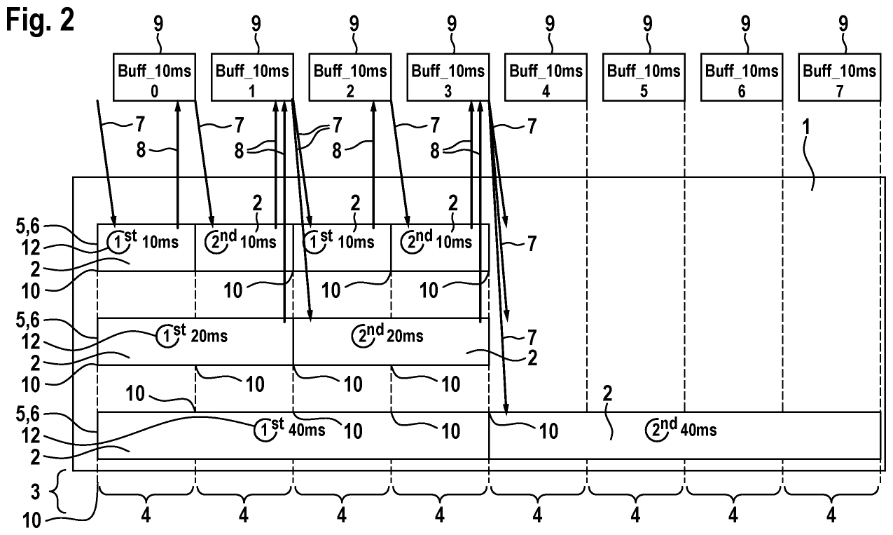

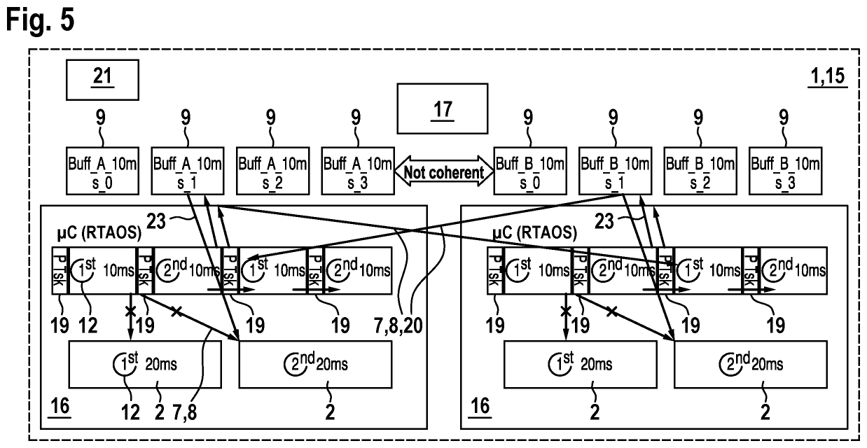

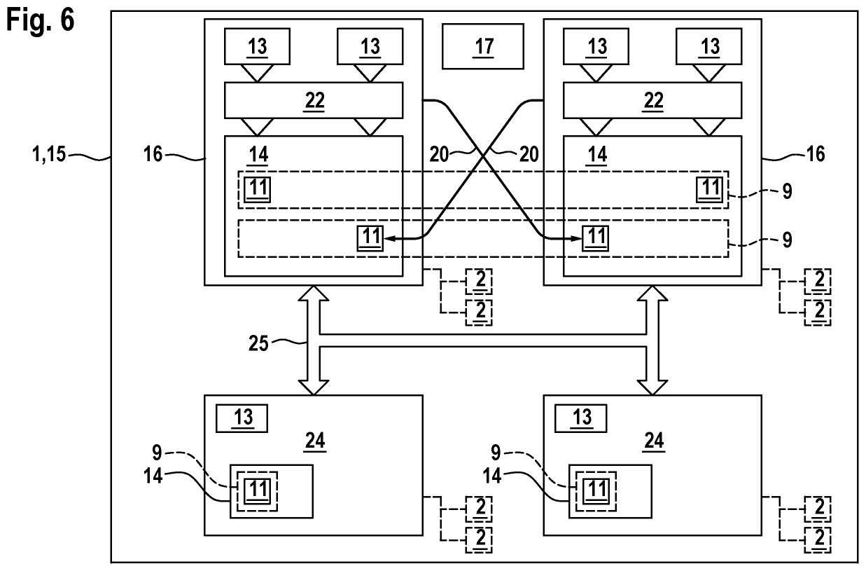

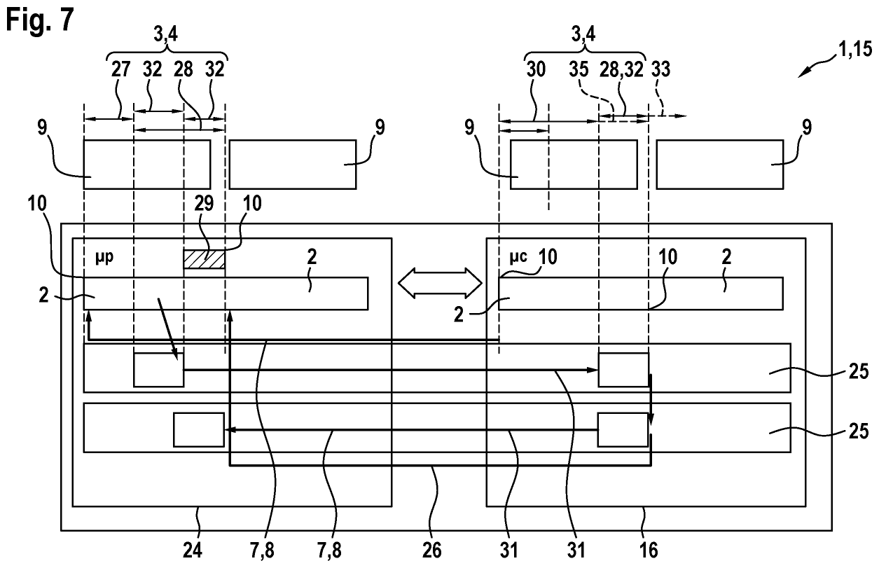

FIG. 2, 3, 4 now show embodiment variants of deterministic communication, as is the basis of the method described here. FIG. 5 illustrates an extension of the principle to data processing devices 15 with a plurality of similar data processing units 16, 24, which is also the basis of the method described here. FIG. 6, then, schematically shows a data processing device 15 for the method described, which device has first data processing units 16 and second data processing units 24. On the basis of FIG. 7, the method described is shown based on FIGS. 1 to 5, which enables the integration of second data processing units 24 in addition to first data processing units 16.

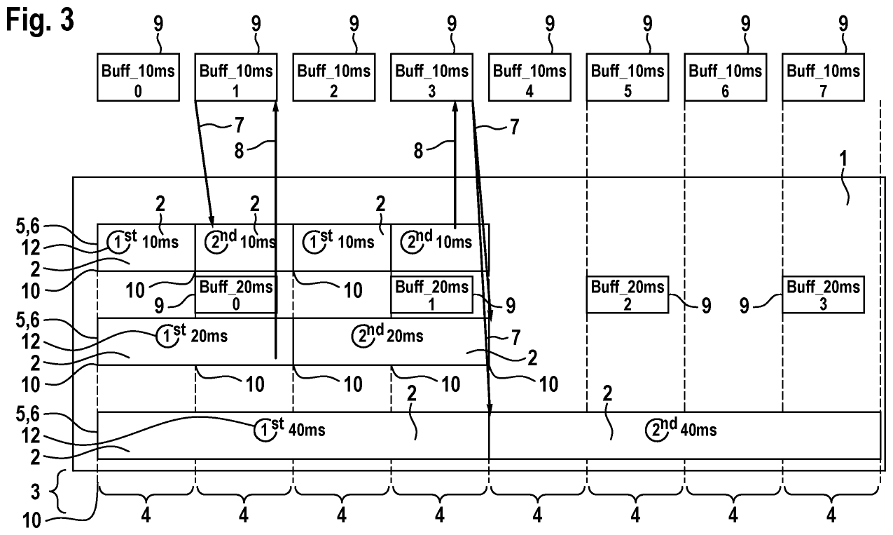

FIG. 2 shows a first variant embodiment of deterministic communication via buffer memories 9 according to the method described herein. Buffer memories 9 are assigned to each of the clock pulses 4 of the grid 3. FIG. 2, as well as the following FIGS. 3, 4 and 5, are each based on FIG. 1 and supplement FIG. 1 with the features essential for the method described herein and for the data processing system 1 described herein. For the sake of clarity, some of the features in FIGS. 2, 3, 4 and 5 are not again provided with reference signs. The explanations for FIG. 1 also apply to FIGS. 2, 3, 4 and 5. There is no exchange of individual messages as in FIG. 1, but, instead, output data 8 are written to currently active buffer memories 9, and input data 7 is read in from buffer memories 9 previously filled with output data 8. To reduce complexity and due to the fact that communication between the data processing tasks 2 takes place exclusively via the buffer memories 9, buffer management preferably takes place at task granularity and not at message granularity. Or in other words: an operating system which provides the environment for the described data processing system 1 and the described method provides the memory for the buffer memories 9 and not the memory for the individual messages. This significantly reduces the number of memory areas to be managed and the communication management effort, compared to management based on the individual communication messages.

Preferably, the buffers for communication are defined statically, i.e., at compile time, and are not changed during the runtime of the data processing system 1. During running operation, access is thus determined by the task activation or the task counter 12. Simple arithmetic is sufficient to determine the buffer memory 9. “True buffer management” is preferably not necessary. Preferably, only targeted access to the correct buffer memory 9 takes place, via addresses that are generated using the task counter 12. It is unambiguously defined for each task which buffer is to be used when.

FIG. 3 shows a second variant embodiment of deterministic communication via buffer memories 9 in a data processing system 1. FIG. 3 is based on FIG. 2, and therefore FIG. 2 can be used here to explain FIG. 3. Here, buffer memories 9 are not only defined for each individual clock pulse 4, but instead individual buffer memories 9 preferably exist in the clock pulse grid for particular communication partners. The term communication partners here means data processing tasks 2 which communicate with one another. This means that one data processing task 2 provides certain output data 8 on a recurring basis that are processed by another data processing task 2. The scheme of which data processing task 2 communicates with which other data processing task 2 is fixed and therefore deterministic. The deterministic communication scheme and the cyclic task scheme and the application of the “single publisher—multiple subscriber” principle enable static management of the buffer memories 9. Preferably, addressing of the buffer memories 9 takes place here based on the fixed communication partners (e.g., in each case via an ID of the communication partners (data processing tasks 2)) and via the task counter 12. Access to the buffers takes place in copy-free fashion as “single publisher multiple subscriber”. The addressing of the individual buffers is then determined by the assignment of the communication participants to their tasks. If, for example, in the example shown in FIG. 3 definition takes place as follows:
2nd 20 ms task receives Buff 10 ms 1: the 2nd 20 ms task uses the task counter of the 10 ms task and the task counter of the 20 ms task and the clock pulse ratio of 10 ms to 20 ms to calculate the correct 10 ms buffer using simple arithmetic;
2nd 40 ms task receives the Buff 10 ms 3 and the Buff 20 ms 1: the 2nd 40 ms task uses the task counter of the 10 ms task and the task counter of the 40 ms task and the clock pulse ratio of 10 ms to 40 ms to calculate the correct 10 ms buffer using simple arithmetic. And the 2nd 40 ms task uses the task counter of the 20 ms task and the task counter of the 40 ms task and the clock pulse ratio of 20 ms to 40 ms to calculate the correct 20 ms buffer using simple arithmetic;
1st 10 ms task sends the Buff 10 ms 1: the 1st 10 ms task uses the task counter of the 10 ms task to calculate the correct 10 ms buffer using simple arithmetic;
etc.

Preferably, the communication from one execution of a data processing task 2 to the next execution of the same data processing task 2 can be carried out according to the same method. This refers to the case where a data processing task 2 processes output data 8 from a previous execution as input data 7. In this case, a data processing task 2 communicates with itself, so to speak, or takes internal, changing status variables into account when processing further input data 7. This case could also be solved using other approaches, e.g., a reserved internal buffer memory 9 for the relevant data processing task 2. However, it can likewise be advantageous to also act uniformly in this case using the described method.

Preferably, less buffer memory 9 could then be required for this.

Advantageously, the number of buffers can be reduced, advantageously on the basis of the actually required communication of output data 8 and input data 7 between data processing tasks 2. FIG. 3 can be used to explain such a reduction, for example for the 40 ms data processing task 2. If this data processing task 2 did not have to receive any data from the 10 ms data processing task 2, then here the number of 10 ms buffer memories 9 could be halved from 8 to 4.

The described method and the described data processing system 1 also open up the possibility of being able to access a plurality of buffer memories 9 simultaneously without extra effort. Since the buffer memories 9 are statically defined, and the clock pulses 4 or the repetition clock pulses 6 are in an integer cycle relationship to each other, a low-frequency data processing task 2 with a low repetition rate 5, for example, can access all the data of the higher-frequency data processing tasks 2 with a higher repetition rate 5. Preferably, this applies with the restriction that only output data 8 are available that were generated in the previous activation period of the associated low-frequency data processing task 2.

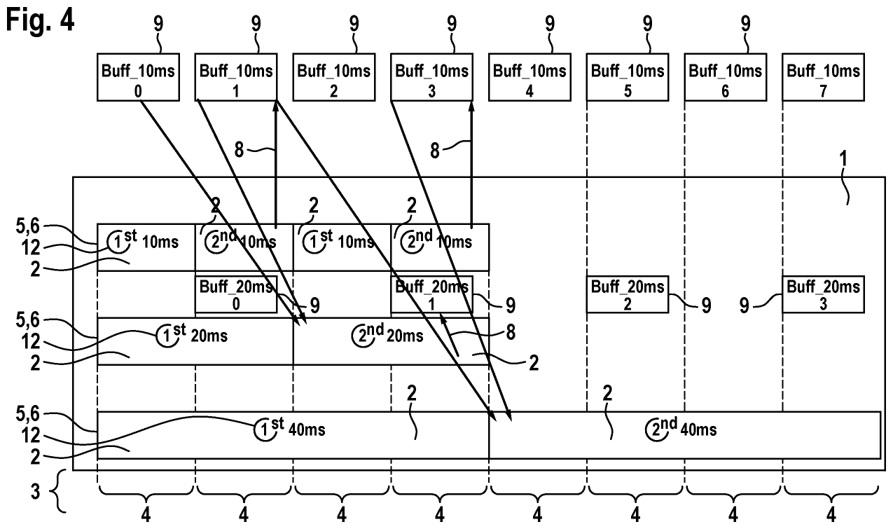

FIG. 4 shows another development; here FIG. 2 and FIG. 3 are also used to explain FIG. 4. In addition, the static allocation of the buffer memories 9 also enables deterministic access to data from multiple activations of higher-frequency data processing tasks 2. This simplifies the processing of data from higher-frequency data processing tasks 2 without the complexity otherwise required to identify and access these data. In the example in FIG. 4, this is done for example as follows:
2nd 20 ms task accesses the data of the 1st and 2nd 10 ms task;
2nd 40 ms task accesses the data from Buff 10 ms 2 and Buff_10 ms_3;
2nd 40 ms task accesses Buff_10 ms_0, Buff_10 ms_1, Buff 10 ms 2 and Buff 10 ms_3;
etc.

FIG. 5 shows how the method described is actually carried out with a data processing system 1, which is set up on a data processing device 15 with two data processing units 16.

In the illustration according to FIG. 5, the details shown in FIGS. 2 and 4 regarding the time grid 3 and the clock pulses 4 have been partially omitted for the sake of clarity and only two data processing tasks 2 per data processing unit 16 are shown as examples. In this respect, the illustration in FIG. 5 is further simplified in accordance with the illustrations in FIGS. 2 and 4.

For each data processing unit 16, here, the data processing tasks 2 that are performed on the relevant data processing unit 16 are shown. Buffer memories 9 for each individual clock pulse 4 are provided here for each data processing unit 16, with the buffer memory areas associated with the same clock pulse 4 each forming a buffer memory 9. Buff A 10 ms_0 thus forms a buffer memory 9 together with Buff B 10 ms_0, Buff A 10 ms_1 forms a buffer memory 9 together with Buff B 10 ms_1, and so on. A buffer memory 9 therefore includes memory areas in memory modules 14 in both data processing units 16. This concept is explained in more detail below with reference to FIG. 6.

The data processing units 16 can access one another. In particular, this means that a data processing unit 16 can access memory areas 11 or buffer memory areas of the buffer memory 9 of the other data processing unit 16, and vice versa. Such accesses from one data processing unit 16 to memory areas 11 of the other data processing unit 16 are referred to here as so-called external memory accesses 20, and they are regularly required when carrying out the described method on a data processing device 15 with a plurality of data processing units 16, namely in particular whenever a data processing task 2 has been executed on a data processing unit 16 in a clock pulse 4 and output data 8 have been stored there in a buffer memory 9 and then (in a subsequent clock pulse) a data processing task 2 is executed on another data processing unit 16 and these output data 8 are required as input data 7. Some external memory accesses 20 are shown schematically in the illustration in FIG. 5. In order to carry out the described method, it is regularly necessary for the data processing device 15 or the data processing units 16 of the data processing device 15 to be set up in each case for the external memory accesses 20 described or to enable such external memory accesses 20 in principle.

The storage of output data 8 of the execution of a data processing task 2 is often carried out on the data processing units 16 in each case with a quite complex mode of operation, which is explained in more detail below using FIG. 6 as an example and the details of which can also vary greatly depending on the type of data processing unit 16. To summarize: if a data processing task 2 stores data in the memory of the relevant data processing unit 16, the visibility of these data for external memory accesses 20 may differ from the visibility of these data for accesses of the data processing unit 16 itself (referred to here as internal memory accesses 23), for example because data are still in internal caches, etc.

In the method described here, for this reason the synchronization function 19, which synchronizes the output data 8, written to the buffer memories 9, of the individual data processing tasks 2, is executed before the start of the data processing task 2 with the highest repetition rate. The execution of the synchronization function 19 ensures in particular that internal memory accesses 23 and external memory accesses 20 each show the same data pool and thus the same stored output data 8 in the buffer memories 9.

Preferably, the data processing device 15 has a higher-level controller 21 which controls the distribution of the individual data processing tasks 2 to the data processing units 16. This distribution can if appropriate be statically defined before the operation of the described data processing system 1 (before the start of the described method). This distribution can also be adjusted during runtime (during operation of the described method), depending on the load.

Preferably, the described data processing device 15 furthermore also has a communication memory 17, via which messages can be exchanged between the individual data processing units 16 of the data processing device 15, without the described differences between the external memory access 20 and the internal memory access 23 occurring. Such communication memories 17 can be additionally used by the synchronization function 19 to exchange information regarding stored output data 8 and thus, if necessary, to provide information that enables external memory access 20 to certain data.

In particular, the synchronization function is also referred to as the so-called pre-task for the data processing task 2 with the highest repetition rate. If necessary, the synchronization function 19 or the pre-task can also be integrated into the task with the highest repetition rate. Particularly preferably, this is done directly as the first action within the data processing task 2.

Preferably, when all synchronization functions 19 have been processed on all involved data processing units 16, the actual execution of the data processing tasks 2 is started.

As a result, consistent data are available to the individual data processing units 16 that use the method. The potential lack of memory coherence of the data processing units 16 is compensated for thanks to the deterministic communication and the synchronized cyclic operation of the method with regard to the communication described in the method.

The deterministic data exchange and the coupling with the cyclic task system make it possible to couple different data processing units 16. FIG. 5 shows the data processing units 16 core A and core B, which are coupled. Preferably, here the measures required to establish memory coherence can be carried out at a few fixedly defined points using the synchronization functions 19. For the successful application of the described method, it must be ensured that all synchronization functions 19 are terminated before the actual data processing tasks 2 start. In the drawing, the synchronization functions 19 on core A and B must be completed before the 10 ms task is activated on core A and B. Since the highest-frequency data processing task 2 with the highest repetition rate (in the drawing: task 10 ms) preferably has the highest priority and the pre-task preferably has the same priority, this ensures that the highest-frequency task (in the drawing: task 10 ms) and the lower-frequency tasks (in the drawing: task 20 ms) are activated after the synchronization function 19 at the earliest. This ensures that the data are transparently available on all data processing units 16 in the next activation.

FIG. 6 schematically shows a data processing device 15 (e.g., a SOC system) for the described method. The data processing device 15 preferably has a plurality of data processing units 16 which each have processors 13 and memory modules 14. The buffer memories 9 are reserved on the memory modules 14, with individual memory areas 11 of the buffer memories 9 being located on the different data processing units 16 or on their memory modules 14, so that the buffer memories 9 are implemented overall across the plurality of data processing units 16. The program code of the data processing modules, which are executed as data processing tasks 2, is preferably also stored on the memory modules 14. Preferably, on the data processing device 15, a higher-level controller 21 is operated which handles the distribution of the individual data processing tasks 2 to the data processing units 16. This can be done at runtime or in advance before initialization of the data processing system 1. It is shown here in sketch form that the data processing tasks 2 are “suspended” from the respective data processing units 16, or that the respective data processing units 16 are provided for performing certain data processing tasks 2.

From the point of view of the higher-level controller, the memory modules 14 and the processors 13 are to be regarded as resources that are made available for the method described. The data processing device 15 forms the data processing system 1 with the program code of the data processing modules and if appropriate also with the necessary functions of a higher-level controller 21/an operating system.

External memory accesses 20 by one data processing unit 16 to the other data processing unit 16 are shown as an example in FIG. 6. Also shown are cache memories 22 for each data processing unit 16. When data are written to the memory modules 14, in some circumstances they first reach such cache memories 22. Internal access to such data is then easily possible for the data processing unit 16 directly after the write operation, because internal access mechanisms within the data processing unit 16 check, if necessary, whether there are still data in such a cache memory 22 that are intended for storage in the memory module 14, and these data are then output (as expected). However, external memory access 20 may not yet be possible because, in particular, such internal access mechanisms (not explained in more detail here) are not available and may not be known. For this reason, the described synchronization function 19 is required to establish memory coherence from the perspective of all data processing units 16.

Preferably, when the highest-frequency task is about to be activated, the synchronization function 19 is activated first on all data processing units 16 involved. The synchronization function 19 ensures memory coherence of the individual data processing units 16. The cache memories 22 include, for example, write buffers, caches and pipelines, etc. The process carried out when performing the synchronization function 19 can also be referred to as “flushing” the memories. Preferably, the cache memory 22 is flushed as required, i.e., written to the actual data memory module 14. In general, specific memory coherence mechanisms of the individual data processing units 16 are used for this purpose as required, which will not be discussed in detail here. These include, for example, so-called fences and memory barriers and specific peripheral accesses to achieve memory coherence.

In addition to the first data processing units 16, the data processing device 15 schematically shown in FIG. 6 also has second data processing units 24. While the first data processing units 16 are optimized for error reduction, and to this end have, for example, additional safety functions implemented in hardware, the second data processing units 24 are optimized for power. That is to say, that larger amounts of data can be processed in a shorter time with the second data processing units 24. First data processing units 16 are preferably so-called “μC” or “μS” units (“C” in this case stands for “control” and “S” for “safety”). Second data processing units 24 are preferably so-called “μP” units. (“P” here stands for “performance”).

Like the first data processing units 16, the second data processing units 24 preferably also have processors 13 and memory modules 14. Preferably, buffer memories 9 or memory areas 11 of buffer memories 9 are also provided on the memory modules 14, wherein buffer memory 9 is preferably understood as a higher-level concept consisting of memory areas 11 on the memory modules 14 of different data processing units 16, 25.

An essential boundary condition for the method described here is that the external memory accesses 20, which are possible between the first data processing units 16 and are shown in FIG. 6, by first data processing units 16 to the memory modules 14 of second data processing units 24 and vice versa are not possible in the same way as between first data processing units 16. However, a data transmission interface 25, which provides the transmission of data between memory modules of first data processing units 16 and second data processing units 24, for example a PCI Express interface, is provided. In order to integrate the second data processing units 24 into the data processing, data must be transmitted via said data transmission interface 25. This is done using the method described here.

FIG. 7 now shows the implementation of the method described here. The illustration in FIG. 7 is based on FIGS. 1 to 5 and is partially simplified. Shown schematically are a first data processing unit 16 and a second data processing unit 24 of the data processing device 15 which preferably forms the data processing system 1 described here, together with the program code for carrying out the described method. A downstream data processing task 2, the grid 3 with the clock pulses 4, and the buffer memory 9 for the individual clocks pulses 4 are shown schematically on each data processing unit 16, 24. Reference is made to FIGS. 1 to 5 for details relating to the data processing tasks 2, the buffer memories 9 of the pulses 4, and the grid. The data processing tasks 2 executed here can also have different repetition clock pulses and repetition rates. The buffer memory 9 can be designed with different memory areas, etc.

In FIG. 7, data transmission interfaces 25 for data transmission between the first data processing units 16 and the second data transmission units 24 are shown in both directions.

The method described is based on the principle that the first data processing unit 16 controls the mode of operation of the second data processing unit 24. Compliance with the clock pulses 4 in the grid 3 is monitored by the first data processing unit 16. The second data processing unit 24 processes its data processing tasks 2 under the control of the first data processing unit 16. The time grid 3 and the clock pulses 4 of the second data transmission unit 24 do not actually have to run exactly synchronously. A clock pulse start in the second data transmission unit 24 can actually have a time lag. However, it is essential that output data 8 of data processing tasks 2, which were executed on the second data transmission unit 24, arrive at the first data processing unit 16 in a timely manner before a start time 10 of the next data processing task 2. If this does not happen, there is a fault which may possibly lead to the method described here being aborted.

At the first start time 10, the first data transmission unit 16 begins processing data processing tasks 2, and the first data processing unit 16 transmits a trigger signal 26 to the second data processing unit 24, which also begins the processing of data processing tasks 2 as a result of the trigger signal 26. Merely the use of the trigger signal 26 results here in a certain latency, which leads to the clock pulses 4 on the second data processing unit 24 running behind. The latency can be understood as the time shift (not shown here) between the grids 3 and the clock pulse 4 of the first data processing unit 16 and the second data processing unit 24. The latency can be even greater than is the case due to the transmission of the trigger signals 26, as will be explained in more detail below. However, the further process for the cooperation of the first data processing unit 16 with the second data processing unit 24 will first be described here.

In the case shown in FIG. 7, it is assumed that the input data 7 for the data processing task 2 shown are already present on the second data processing unit 24. The data processing of the data processing task 2 on the second data processing unit 24 begins with the trigger signal 26. A sub-period 27 of the clock pulse 4 is available here for the data processing task 2. The data processing must be completed within the sub-period 27, so that there is still sufficient remaining time 28 for data transmission 31 of the output data 8 via the data transmission interface 25. The data transmission 31 of the output data 8 takes place here directly following the sub-period 27.

In parallel, the processing of a data processing task 2 also takes place on the first data processing unit 16. This takes place within the processing time period 30 shown here, which is normally shorter than the clock pulse 4, which, however, can optionally be expanded by the reserve time 35 over the entire clock pulse 4. This will be discussed further later in connection with the latency already mentioned above.

As soon as both data processing tasks 2 are completed on the first data processing unit 16 and on the second data processing unit 24, the data transmissions 31 take place between the first data processing unit 16 and the second data processing unit 24 in order to then provide the corresponding output data 8 for subsequent data processing tasks 2 as input data 7. The data transmissions 31 each require a transmission period 32 which must be able to be imaged within the available remaining time 28 so that these data are then available as input data 7 for the subsequent data processing task 2 on the corresponding data processing units 16, 24. FIG. 7 shows a second trigger signal 26 which triggers the processing of a next data processing task 2 on the second data processing unit 24. In parallel therewith, the next data processing task 2 is also started on the first data processing unit 16. However, the further trigger signal 26 is triggered only when all input data 7 are available. Otherwise, an error is output.

In fact, the processing duration of the data processing tasks 2 is limited to a sub-period 27 only on second data processing units 24.

The effect described below can further increase the latency already mentioned above between the data processing on the first data processing units 16 and the second data processing units 24, without this negatively affecting the described method, and at the same time allows the available length of the clock pulses 4 on the first data processing units 16 to be fully utilized.

A processing time period 30 for processing the data processing task 2 is now available to the first data processing unit 16, which first time period does not initially fully correspond to the length of the clock pulse 4, because a transmission time period 32 should also be available within the clock pulse 4 in order to transmit output data 8 of the data processing on the first data processing unit 16 via the data transmission interface 25 to the second data processing unit 24. In fact, however, the length of the clock pulse 4 can be fully used on the first data processing unit 16, since the transmission period 32 can be shifted into the lag time 33 shown here. The reserve time 35 shown is thus still available to the data processing. The data transmission 31 then takes place in parallel to the processing of the next data processing task 2. This is shown here schematically as parallel data transmission 34 (data transmission associated with a data processing task 2 previously carried out, which takes place parallel to the processing of a data transmission task 2). Technically, this is not a problem. The data transmission 31 which still takes place in the lag time 33 does not impair the processing of the next data processing task 2. In fact, this can result in a further shift of the clock pulses 4 of the data processing on the second data processing unit 24, which, however, is not a problem as long as the data processing task 2 and the return transmission of the output data 8 from the second data processing unit 24 to the first data processing unit 16 are concluded within the clock pulse 4, so that, at the next start time 10, all data are again available on the first data processing unit 16. A shift of the grid 3 or of the clock pulses 4 for data processing tasks 2 executed on second data processing units 24 can thus take place, which still allows sufficient remaining time 28 for the transmission of output data 8 of the executed data processing tasks 2 back to the first data processing units 16.

This type of cooperation of first data processing units 16 and second data processing units 24 makes it possible for the length of the clock pulses 4 to be fully utilized on the first data processing unit 16, and a limitation is present only on second data processing units 24, for the available clock pulses 4 to be used only partially (for a sub-period 27), so that there is still sufficient time for the data transmission 31 via the data transmission interface 25. However, this limitation of the data processing on the second data processing units 24 is not a disadvantage. Further data processing operations 29 can take place in parallel on the second data processing units 24, the processing of which operations, due to a lower prioritization, is downstream of the data processing tasks 2 executed as part of the described method. The remaining time 28 not used on the second data processing units 24 by the described method can therefore be used effectively for further data processing operations 29.

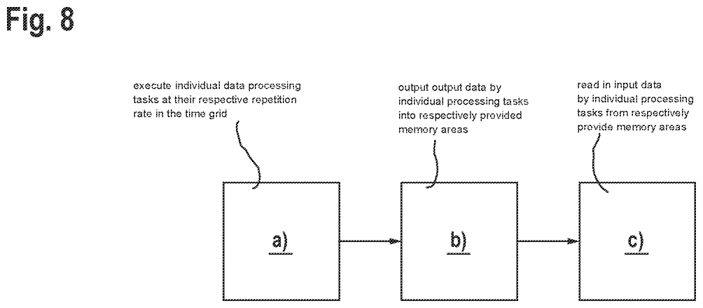

FIG. 8 shows, very schematically, a flowchart of the described method. The individual method steps a), b), and c) are shown, which are carried out according to the described method. When carrying out the described method, the method steps are preferably repeated regularly for each data processing task 2. This results overall in cooperation of the individual data processing tasks 2 in the data processing system 1, which results in processing of system input data (e.g., environment sensor data etc.) to form system output data (e.g., decision data for highly automated driving functions).

Overall, the described method discloses a novel approach for allowing deterministic communication in a fixed grid 3 of clock pulses 4, even with a complex SOC hardware architecture, without all data processing units having common or coherent memory access. A structure is thus created for setting up a data processing system 1 on such a data processing device 15 very efficiently and very effectively.

1-16. (canceled)

17. A method for operating a data processing system for processing data, wherein the data processing system is set up for repeated execution of a plurality of individual data processing tasks, wherein:
a time grid with clock pulses is provided for execution of the individual data processing tasks,
a predetermined respective repetition rate is specified for each of the individual data processing tasks, wherein the respective repetition rates each define a repetition clock pulse which corresponds in each case to an integer number of clock pulses of the grid,
the repetition clock pulse of a data processing task of the individual data processing tasks with a highest respective repetition rate corresponds to the clock pulses of the time grid,
the individual data processing tasks build on one another, so that at least one of the data processing tasks processes output data of a further one of the data processing tasks as input data,
a number of buffer memories are provided, which are assigned to the clock pulses of the time grid and are available in turn, so that output data generated during a relevant clock pulse of the clock pulses of the grid are written to the assigned buffer memory, and output data generated during previous clock pulses are still available in other buffer memories for a number of clock pulses,
the data processing system is operated on a data processing device including at least one first data processing unit and including at least one second data processing unit, which in each case include processors and memory modules, wherein data transmission interfaces exist for data transmission between the first and second data processing units, wherein each of the individual data processing tasks is associated with at least one first data processing unit of the at least one first data processing unit or at least one second data processing unit of the at least one second data processing unit, and memory areas of the buffer memories are made available to the memory modules of the at least one first data processing unit and the at least one second data processing unit;
wherein the following steps are carried out for the operation of the data processing system:
a) executing each of the individual data processing tasks at its respective repetition rate in the time grid on one of the first and second data processing units of the data processing system;
b) outputting output data by the individual data processing tasks into respectively available memory areas of the buffer memory which is assigned to the clock pulse of the grid, wherein output data generated by those of the individual data processing tasks executing on second data processing units of the at least one second data processing unit are transmitted via the data transmission interfaces after output into memory areas of the buffer memory of first data processing units of the at least one first data processing unit; and
c) reading in input data by the individual data processing tasks from respectively available memory areas of the buffer memory, which are associated with preceding clock pulses of the grid, wherein those of the input data, which are required by those of the individual data processing tasks executing on second data processing units of the at least one second data processing unit, are transmitted via the data transmission interfaces into memory areas of the buffer memory on second data processing units of the at least one second data processing unit before being read in.

18. The method according to claim 17, wherein the at least one first data processing unit is a data processing unit optimized for error reduction, and wherein the at least one second data processing unit is a data processing unit optimized for power.

19. The method according to claim 17, wherein the execution of each of those of the individual data processing tasks on a second data processing unit of the at least one second second data processing units according to step a) is started by a trigger signal which is sent by a first data processing unit of the at least one first data processing units when a transmission of output data to a corresponding second data processing unit of the at least one second data processing unit is completed according to step b).

20. The method according to claim 17, wherein each of the individual data processing tasks to be executed by a second data processing unit of the at least one second data processing unit is implemented in such a way that a sub-period of the respective repetition clock pulse of the individual data processing task is sufficient to complete data processing of the individual data processing task, wherein the sub-period is selected such that, within the respective repetition clock pulse, there is still remaining time for transmitting output data according to step b) and for transmitting input data according to step c).

21. The method according to claim 20, wherein, in addition to the individual data processing task, further data processing operations, which are executed within the remaining time, are performed on a second data processing device of the at least one second data processing device so that a capacity of the second data processing device is fully available for the execution of the individual data processing task during the sub-period.

22. The method according to claim 17, wherein the time grid is specified by first data processing units of the at least one first data processing unit, and a clock pulse shift can occur between clock pulses of the first data processing units and clock pulses of second data processing units of the at least one second data processing unit, the clock pulse shift being post-synchronized regularly by trigger signals from the first data processing units to the second data processing units.

23. The method according to claim 17, wherein a transmission of the output data of those of the individual data processing tasks which have been executed on a second data processing unit of the at least one second data processing unit is initiated after the generation of the output data by the second data processing unit.

24. The method according to claim 17, wherein a transmission of the input data for those of the individual data processing task, which are executed on a second data processing unit of the at least one second data processing unit, to the second data processing unit by a first data processing unit of the at least one first processing unit is initiated after the input data have been stored as output data in the buffer memory of the first data processing unit.

25. The method according to claim 24, wherein the transmission of the input data by the first data processing unit to the second data processing unit takes place in parallel with the execution of further ones of the individual data processing tasks on the first data processing unit.

26. The method according to claim 17, wherein first data processing units of the at least one first data processing unit monitor that second data processing units of the at least one second data processing terminate associated data processing units such that the output data are available for data processing of preceding clock pulses in each clock pulse.

27. The method according to claim 17, wherein, for step a), a controller of the data processing system, which controller is higher level relative to the individual data processing tasks, determines on which data processing unit of the at least one first and second data processing units an individual data processing task of the individual data processing tasks is executed.

28. The method according to claim 17, wherein, for steps b) and c), a controller that is higher level relative to the individual data processing tasks determines on which memory area of a buffer memory of the buffer memories particular data processing tasks of the individual processing tasks will store their output data so as to be capable of being read in as input data by others of the individual data processing tasks.

29. The method according to claim 17, wherein a higher-level controller of the data processing system s operated on a data processing unit optimized for error reduction.

30. A data processing device, comprising:
at least one first data processing unit optimized for error reduction and at least one second data processing unit optimized for performance, which each include one or more processors and one or more memory modules, wherein the data processing device is configured such that it can be operated as a data processing system for processing data, wherein the data processing system is set up for repeated execution of a plurality of individual data processing tasks, wherein:
a time grid with clock pulses is provided for execution of the individual data processing tasks,
a predetermined respective repetition rate is specified for each of the individual data processing tasks, wherein the respective repetition rates each define a repetition clock pulse which corresponds in each case to an integer number of clock pulses of the grid,
the repetition clock pulse of a data processing task of the individual data processing tasks with a highest respective repetition rate corresponds to the clock pulses of the time grid,
the individual data processing tasks build on one another, so that at least one of the data processing tasks processes output data of a further one of the data processing tasks as input data,
a number of buffer memories are provided, which are assigned to the clock pulses of the time grid and are available in turn, so that output data generated during a relevant clock pulse of the clock pulses of the grid are written to the assigned buffer memory, and output data generated during previous clock pulses are still available in other buffer memories for a number of clock pulses,
wherein data transmission interfaces exist for data transmission between the first and second data processing units, wherein each of the individual data processing tasks is associated with at least one first data processing unit of the at least one first data processing unit or at least one second data processing unit of the at least one second data processing unit, and memory areas of the buffer memories are made available to the memory modules of the at least one first data processing unit and the at least one second data processing unit;
wherein, for the operation of the data processing system:
a) each of the individual data processing tasks is executed at its respective repetition rate in the time grid on one of the first and second data processing units of the data processing system;
b) output data is output by the individual data processing tasks into respectively available memory areas of the buffer memory which is assigned to the clock pulse of the grid, wherein output data generated by those of the individual data processing tasks executing on second data processing units of the at least one second data processing unit are transmitted via the data transmission interfaces after output into memory areas of the buffer memory of first data processing units of the at least one first data processing unit; and
c) input data is read in by the individual data processing tasks from respectively available memory areas of the buffer memory, which are associated with preceding clock pulses of the grid, wherein those of the input data, which are required by those of the individual data processing tasks executing on second data processing units of the at least one second data processing unit, are transmitted via the data transmission interfaces into memory areas of the buffer memory on second data processing units of the at least one second data processing unit before being read in.

31. A non-transitory computer-readable storage medium on which are stored commands for operating a data processing system for processing data, wherein the data processing system is set up for repeated execution of a plurality of individual data processing tasks, wherein:
a time grid with clock pulses is provided for execution of the individual data processing tasks,
a predetermined respective repetition rate is specified for each of the individual data processing tasks, wherein the respective repetition rates each define a repetition clock pulse which corresponds in each case to an integer number of clock pulses of the grid,
the repetition clock pulse of a data processing task of the individual data processing tasks with a highest respective repetition rate corresponds to the clock pulses of the time grid,
the individual data processing tasks build on one another, so that at least one of the data processing tasks processes output data of a further one of the data processing tasks as input data,
a number of buffer memories are provided, which are assigned to the clock pulses of the time grid and are available in turn, so that output data generated during a relevant clock pulse of the clock pulses of the grid are written to the assigned buffer memory, and output data generated during previous clock pulses are still available in other buffer memories for a number of clock pulses,
the data processing system is operated on a data processing device including at least one first data processing unit and including at least one second data processing unit, which in each case include processors and memory modules, wherein data transmission interfaces exist for data transmission between the first and second data processing units, wherein each of the individual data processing tasks is associated with at least one first data processing unit of the at least one first data processing unit or at least one second data processing unit of the at least one second data processing unit, and memory areas of the buffer memories are made available to the memory modules of the at least one first data processing unit and the at least one second data processing unit;
wherein the commands, when executed by a computer, cause the computer to perform the following steps for the operation of the data processing system:
aa) executing each of the individual data processing tasks at its respective repetition rate in the time grid on one of the first and second data processing units of the data processing system;
b) outputting output data by the individual data processing tasks into respectively available memory areas of the buffer memory which is assigned to the clock pulse of the grid, wherein output data generated by those of the individual data processing tasks executing on second data processing units of the at least one second data processing unit are transmitted via the data transmission interfaces after output into memory areas of the buffer memory of first data processing units of the at least one first data processing unit; and
c) reading in input data by the individual data processing tasks from respectively available memory areas of the buffer memory, which are associated with preceding clock pulses of the grid, wherein those of the input data, which are required by those of the individual data processing tasks executing on second data processing units of the at least one second data processing unit, are transmitted via the data transmission interfaces into memory areas of the buffer memory on second data processing units of the at least one second data processing unit before being read in.
